(19) United States
(12) Patent Application Publication
(10) Pub. No.: US 2021/0295563 A1
(43) Pub. Date: Sep. 23, 2021

(54) IMAGE PROCESSING APPARATUS, IMAGE PROCESSING METHOD, AND PROGRAM

(71) Applicant: Sony Corporation, Tokyo (JP)

(72) Inventors: Suguru AOKI, Tokyo (JP); Takuto MOTOYAMA, Tokyo (JP); Masahiko TOYOSHI, Tokyo (JP); Yuki YAMAMOTO, Tokyo (JP)

(73) Assignee: Sony Corporation, Tokyo (JP)

(21) Appl. No.: 17/265,837

(22) PCT Filed: Jul. 23, 2019
(86) PCT No.: PCT/JP2019/028785

§ 371 Date: Feb. 4, 2021

(30) Foreign Application Priority Data
Aug. 16, 2018 (JP) 2018-153172

(51) Int. Cl. G06T 7/80; G06T 3/00; G06T 3/60; G06T 5/00

(52) U.S. Cl. CPC G06T 7/80; G06T 3/0018; G06T 2207/30196; G06T 5/009; G06T 3/608

(57) ABSTRACT

A recognition processing section performs subject recognition in a processing area of an image obtained by an imaging section. The recognition processing section determines an image characteristic of the processing area on the basis of a characteristic map indicating an image characteristic of the image obtained by the imaging section and uses a recognizer corresponding to the image characteristic of the processing area. The characteristic map includes a map based on an optical characteristic of an imaging lens used in the imaging section and is stored in a characteristic information storage section. An imaging lens has a winder angle of view in all directions or in a predetermined direction than a standard lens, and the optical characteristic thereof differs depending on a position on the lens. The recognition processing section performs the subject recognition using a recognizer corresponding to resolution or skewness of the processing area, for example.

### TECHNICAL FIELD

The present technology relates to an image processing apparatus, an image processing method, and a program and enables accurate subject recognition.

### BACKGROUND ART

Conventionally, in a case where both a distant area and a near area are captured by using a wide-angle lens, a portion with deteriorated image quality is, in some cases, generated in an image due to a change rate of an incidence angle per image height. Accordingly, in PTL 1, a magnification of a central area in which the incidence angle is smaller than an inflection point incidence angle is set to be larger than that of a peripheral area in which the incidence angle is larger than the inflection point incidence angle. This increases a detection distance of the central area while decreasing a detection distance of the peripheral area that has a wide range. Further, in order to recognize a target object, resolution of at least one of the central area or the peripheral area is set to be high, while resolution of an inflection point corresponding area corresponding to the inflection point incidence angle is, as a blurred area, set to be lower than that of the central area and the peripheral area.

### CITATION LIST

### Patent Literature

### [PTL 1]

Japanese Patent Laid-Open No. 2016-207030

### SUMMARY

### Technical Problem

Incidentally, there is a possibility that non-uniformity of the resolution in an image deteriorates performance of the subject recognition. For example, if the subject is included in the inflection point corresponding area of PTL 1, there is a possibility that the subject cannot be recognized accurately.

Therefore, it is an object of the present technology to provide an image processing apparatus, an image processing method, and a program that can accurately perform the subject recognition.

### Solution to Problem

A first aspect of the present technology lies in an image processing apparatus including a recognition processing section configured to perform subject recognition in a processing area in an image obtained by an imaging section, by using a recognizer corresponding to an image characteristic of the processing area.

In the present technology, at the time of performing the subject recognition in the processing area in the image obtained by the imaging section, the image characteristic of the processing area is determined on the basis of a characteristic map indicating an image characteristic of the image obtained by the imaging section and the recognizer corresponding to the image characteristic of the processing area is used. The characteristic map includes a map based on an optical characteristic of an imaging lens used in the imaging section. The imaging lens has a wider angle of view in all directions or in a predetermined direction than a standard lens and the optical characteristic of the imaging lens differs depending on a position on the lens. A recognizer corresponding to, for example, resolution or skewness of the processing area is used to perform the subject recognition in the processing area. Further, in a case where template matching is performed using the recognizer, for example, a size and an amount of movement of a template may be adjusted according to the optical characteristic of the imaging lens.

Further, an imaging lens corresponding to an imaging scene can be selected. The recognizers configured to perform the subject recognition in the processing area in the image obtained using the selected imaging lens are switched according to the image characteristic of the processing area determined using the characteristic map based on an optical characteristic of the selected imaging lens. The imaging scene is determined on the basis of at least any of image information acquired by the imaging section, operation information of a mobile object including the imaging section, or environment information indicating an environment in which the imaging section is used.

Further, the image characteristic of the processing area is determined using the characteristic map based on a filter arrangement state of an image sensor used in the imaging section and a recognizer corresponding to arrangement of a filter corresponding to the processing area is used to perform the subject recognition in the processing area. The filter arrangement state includes an arrangement state of a color filter and includes, for example, a state in which in a central portion of an imaging area in the image sensor, the color filter is not arranged or a filter configured to transmit only a specific color is arranged. Further, the filter arrangement state may include an arrangement state of an infrared cut-off filter. For example, the filter arrangement state includes a state in which the infrared cut-off filter is arranged only in the central portion of the imaging area in the image sensor.

A second aspect of the present technology lies in an image processing method including performing, by a recognition processing section, subject recognition in a processing area in an image obtained by an imaging section, by using a recognizer corresponding to an image characteristic of the processing area.

A third aspect of the present technology lies in a program for causing a computer to perform recognition processing, and the program causes the computer to perform a process of detecting an image characteristic of a processing area in an image obtained by an imaging section, and a process of causing subject recognition to be performed in the processing area using a recognizer corresponding to the detected image characteristic.

It is noted that the program according to the present technology is, for example, a program that can be provided by a storage medium or a communication medium that provides various program codes in a computer-readable form to a general-purpose computer that can execute those various program codes. Examples of the storage medium include an optical disc, a magnetic disk, a semiconductor memory, and the like. Examples of the communication medium include a network. By providing such a program in the computer-readable form, processing corresponding to the program is performed on the computer.

### Advantageous Effect of Invention

According to the present technology, a recognizer corresponding to an image characteristic of a processing area in an image obtained by an imaging section is used to perform subject recognition in the processing area. Therefore, the subject recognition can be performed accurately. It is noted that the effects described in the present specification are merely examples and are not limitative. Further, additional effects may be provided.

### BRIEF DESCRIPTION OF DRAWINGS

FIG. 1 is a diagram exemplifying lenses used at the time of imaging and optical characteristics of the lenses.

FIG. 2 is a diagram exemplifying a configuration of a first embodiment.

FIG. 3 is a flowchart exemplifying an operation of the first embodiment.

FIG. 4 is a diagram for describing the operation of the first embodiment.

FIG. 5 is a diagram exemplifying a configuration of a second embodiment.

FIG. 6 is a flowchart exemplifying an operation of the second embodiment.

FIG. 7 is a diagram for describing the operation of the second embodiment.

FIG. 8 is a diagram exemplifying a configuration of a third embodiment.

FIG. 9 is a diagram exemplifying an imaging surface of an image sensor.

FIG. 10 is a flowchart exemplifying an operation of the third embodiment.

FIG. 11 is a diagram exemplifying the imaging surface of the image sensor.

FIG. 12 is a block diagram illustrating an example of a schematic functional configuration of a vehicle control system.

### DESCRIPTION OF EMBODIMENTS

Modes for carrying out the present technology will be described below. It is noted that description will be given in the following order.

1. First Embodiment
1-1. Configuration of First Embodiment
1-2. Operation of First Embodiment

2. Second Embodiment
2-1. Configuration of Second Embodiment
2-2. Operation of Second Embodiment

3. Third Embodiment
3-1. Configuration of Third Embodiment
3-2. Operation of Third Embodiment

4. Modifications

5. Application Examples

### 1. First Embodiment

In order to acquire an image in which a subject in a wide range is captured, an imaging system uses a wide-angle lens (e.g., a fisheye lens) with a wider angle of view in all directions than a commonly used standard lens with less distortion. Further, in some cases, a cylindrical lens is also used to acquire a captured image with a wide angle of view in a particular direction (e.g., a horizontal direction).

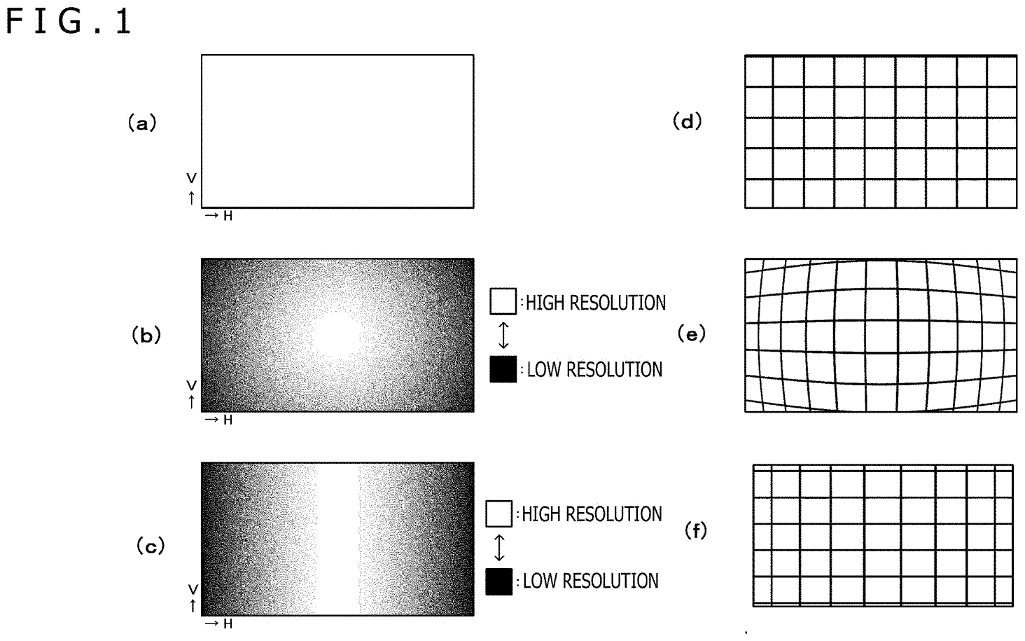

FIG. 1 is a diagram exemplifying lenses used at the time of imaging and optical characteristics of the lenses. (a) of FIG. 1 exemplifies a resolution map of a standard lens. (b) of FIG. 1 exemplifies a resolution map of a wide-angle lens. (c) of FIG. 1 exemplifies a resolution map of a cylindrical lens. It is noted that, as indicated in the resolution maps, areas with high luminance have high resolution while areas with low luminance have low resolution. Further, skewness maps of the standard lens and the wide-angle lens and a skewness map of the cylindrical lens for a horizontal direction H are similar to the respective resolution maps, and the skewness increases as the luminance decreases. Further, a skewness map of the cylindrical lens for a vertical direction V is similar to the skewness map of the standard lens.

With the standard lens, as illustrated in (a) of FIG. 1, the resolution is high and the skewness is low in the entire area. For example, as illustrated in (d) of FIG. 1, when a grid-shaped subject is captured, an image with high resolution and no distortion can be acquired.

With the wide-angle lens, as illustrated in (b) of FIG. 1, the resolution decreases and the skewness increases at locations more distant from the center of the image. Accordingly, as illustrated in (e) of FIG. 1, when the grid-shaped subject is captured, for example, the resolution decreases and the skewness increases at locations more distant from the center of the image.

With the cylindrical lens, as illustrated in (c) of FIG. 1, for example, the resolution in the vertical direction is constant and the skewness therein is small, while the resolution in the horizontal direction decreases and the skewness therein increases at locations more distant from the center of the image. Therefore, as illustrated in (f) of FIG. 1, when the grid-shaped subject is captured, the resolution and the skewness in the vertical direction are constant, while the resolution in the horizontal direction decreases and the skewness therein increases at locations more distant from the center of the image.

In this manner, using the imaging lens with a wider angle of view than the standard lens makes the resolution and the skewness vary depending on the position in the image. Therefore, according to a first embodiment, in order to perform subject recognition accurately, a recognizer corresponding to an image characteristic of a recognition area in a characteristic map based on an optical characteristic of the imaging lens is used for each recognition area in an image obtained by an imaging section.

<1-1. Configuration of First Embodiment>

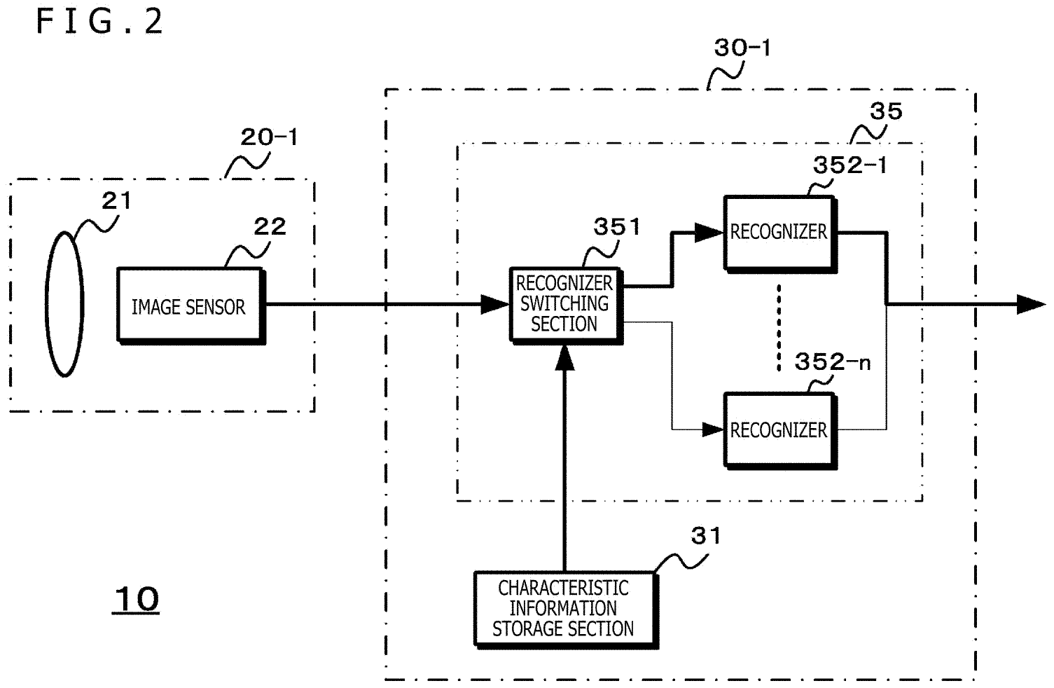

FIG. 2 exemplifies a configuration of the first embodiment. An imaging system 10 includes an imaging section 20-1 and an image processing section 30-1.

An imaging lens 21 of the imaging section 20-1 uses an imaging lens, for example, a fisheye lens or a cylindrical lens, with a wider angle of view than the standard lens. The imaging lens 21 forms a subject optical image with a wider angle of view than the standard lens on an imaging surface of an image sensor 22 of the imaging section 20-1.

The image sensor 22 includes, for example, a CMOS (Complementary Metal Oxide Semiconductor) image sensor or a CCD (Charge Coupled Device) image. The image sensor 22 generates image signals corresponding to the subject optical image and outputs the image signals to the image processing section 30-1.

The image processing section 30-1 performs subject recognition on the basis of the image signals generated by the imaging section 20-1. The image processing section 30-1 includes a characteristic information storage section 31 and a recognition processing section 35.

The characteristic information storage section 31 stores, as characteristic information, a characteristic map based on an optical characteristic relevant to the imaging lens 21 used in the imaging section 20-1. A resolution map, a skewness map, or the like of the imaging lens is used as the characteristic information (characteristic map), for example. The characteristic information storage section 31 outputs the stored characteristic map to the recognition processing section 35.

The recognition processing section 35 performs subject recognition in a processing area in an image, which has been obtained by the imaging section 20-1, using a recognizer corresponding to an image characteristic of the processing area. The recognition processing section 35 includes a recognizer switching section 351 and a plurality of recognizers 352-1 to 352-n. The recognizers 352-1 to 352-n are provided according to the optical characteristic of the imaging lens 21 used in the imaging section 20-1. Provided is the plurality of recognizers suitable for images with different resolutions, such as a recognizer suitable for an image with high resolution and a recognizer suitable for an image with low resolution, for example. The recognizer 352-1 is, for example, a recognizer that can perform machine learning or the like using learning images with high resolution and recognize a subject with high accuracy from a captured image with high resolution. Further, the recognizers 352-2 to 352-n are recognizers that can perform machine learning or the like using learning images with different resolutions from each other and recognize a subject with high accuracy from a captured image with a corresponding resolution.

The recognizer switching section 351 detects the processing area on the basis of the image signals generated by the imaging section 20-1. Further, the recognizer switching section 351 detects the resolution of the processing area on the basis of the position of the processing area on the image and the resolution map, for example, and switches the recognizer used for subject recognition processing to a recognizer corresponding to the detected resolution. The recognizer switching section 351 supplies the image signals to the switched recognizer 352-x to recognize a subject in the processing area and output the result of the recognition from the image processing section 30-1.

Further, the recognizers 352-1 to 352-n may be provided according to the skewness of the imaging lens 21. Provided is the plurality of recognizers suitable for images with different skewness, such as a recognizer suitable for an image with small skewness and a recognizer suitable for an image with large skewness, for example. The recognizer switching section 351 detects the processing area on the basis of the image signals generated by the imaging section 20-1 and switches the recognizer used for the subject recognition processing to a recognizer corresponding to the detected skewness. The recognizer switching section 351 supplies the image signals to the switched recognizer 352-x to recognize a subject in the processing area and output the result of the recognition from the image processing section 30-1.

Further, for example, in a case where the recognition processing section 35 performs matching using a learned dictionary (such as a template indicating a subject for learning) in subject recognition, the recognition processing section 35 may adjust a size of the template so as to be able to obtain equivalent recognition accuracy regardless of differences in resolution and skewness. For example, a subject area of a peripheral portion of an image is smaller than that of a central portion thereof. Therefore, the recognition processing section 35 makes the size of the template in the peripheral portion of the image smaller than that of the central portion. Further, for example, when the recognition processing section 35 moves the template to detect a high similarity position, the recognition processing section 35 may adjust an amount of movement of the template so as to reduce the amount of movement in the peripheral portion, compared to the central portion, for example.

<1-2. Operation of First Embodiment>

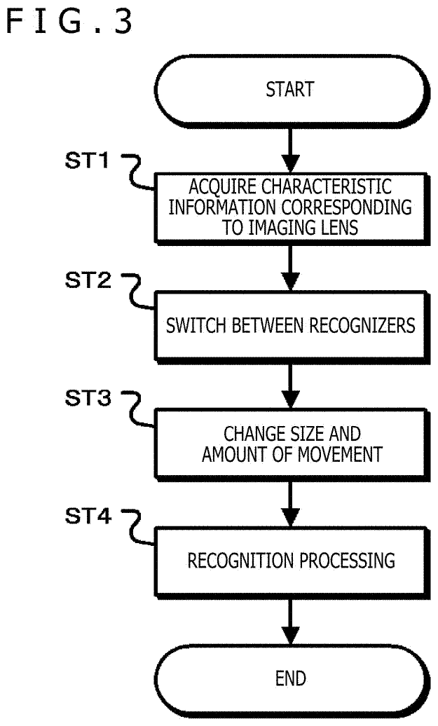

FIG. 3 is a flowchart exemplifying an operation of the first embodiment. In step ST1, the image processing section 30-1 acquires characteristic information corresponding to the imaging lens. The recognition processing section 35 of the image processing section 30-1 acquires a characteristic map based on the optical characteristic of the imaging lens 21 used in the imaging section 20-1 and proceeds to step ST2.

In step ST2, the image processing section 30-1 switches between the recognizers. On the basis of the characteristic information acquired in step ST1, the recognition processing section 35 of the image processing section 30-1 switches to a recognizer corresponding to an image characteristic of a processing area in which recognition processing is performed, and proceeds to step ST3.

In step ST3, the image processing section 30-1 changes the size and the amount of movement. When the recognition processing section 35 of the image processing section 30-1 performs subject recognition using the recognizer switched in step ST2, the image processing section 30-1 changes the size of the template and the amount of movement in matching processing according to the image characteristic of the processing area and proceeds to step ST4.

The image processing section 30-1 performs the recognition processing in step ST4. By using the image signals generated by the imaging section 20-1, the recognition processing section 35 of the image processing section 30-1 performs the recognition processing using the recognizer switched in step ST2.

It is noted that the operation of the first embodiment is not limited to the operation illustrated in FIG. 3. For example, the recognition processing may be performed without performing the processing in step ST3.

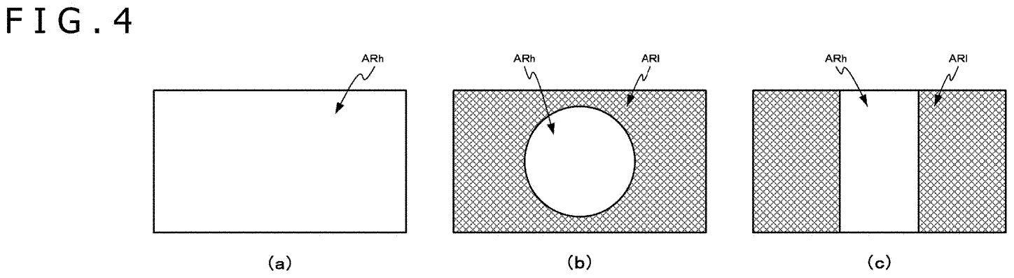

FIG. 4 is a diagram for describing the operation of the first embodiment. (a) of FIG. 4 illustrates a resolution map of the standard lens. Further, as a binary characteristic map, (b) of FIG. 4 exemplifies a resolution map of the wide-angle lens, and (c) of FIG. 4 exemplifies a resolution map of the cylindrical lens, for example. It is noted that in FIG. 4, a map area ARh is an area with high resolution while a map area AR1 is an area with low resolution.

For example, the recognition processing section 35 includes the recognizer 352-1 and the recognizer 352-2. The recognizer 352-1 performs recognition processing using a dictionary for high resolution that has learned using teacher images with high resolution. The recognizer 352-2 performs recognition processing using a dictionary for low resolution that has learned using teacher images with low resolution.

The recognizer switching section 351 of the recognition processing section 35 determines whether the processing area in which the recognition processing is performed belongs to the map area ARh with high resolution or the map area AR1 with low resolution. In a case where the processing area includes the map area ARh and the map area AR1, the recognizer switching section 351 determines whether the processing area belongs to the map area ARh or the map area AR1 on the basis of the statistics or the like. For example, the recognizer switching section 351 determines whether each pixel of the processing area belongs to the map area ARh or the map area AR1, and determines the map area to which more pixels belong as the map area to which the processing area belongs. Further, the recognizer switching section 351 may set a weight to each pixel of the processing area with a central portion weighted more than a peripheral portion. Then, the recognizer switching section 351 may compare a cumulative value of the weight of the map area ARh with a cumulative value of the weight of the map area AR1 and determine the area having a larger cumulative value as the map area to which the processing area belongs. Further, the recognizer switching section 351 may determine the map area to which the processing area belongs by using another method, such as by setting the map area with higher resolution as the map area to which the processing area belongs, for example. In a case where the recognizer switching section 351 determines that the processing area belongs to the map area ARh, the recognizer switching section 351 switches to the recognizer 352-1. Therefore, in a case where the processing area is a high resolution area, it is possible to accurately recognize a subject in the processing area on the basis of the dictionary for high resolution using the image signals generated by the imaging section 20-1. Further, in a case where the recognizer switching section 351 determines that the processing area belongs to the map area AR1, the recognizer switching section 351 switches to the recognizer 352-2. Therefore, in a case where the processing area is a low resolution area, it is possible to accurately recognize a subject in the processing area on the basis of the dictionary for low resolution using the image signals generated by the imaging section 20-1.

Further, the recognizer switching section 351 of the recognition processing section 35 may determine whether the processing area in which the recognition processing is performed belongs to a map area with low skewness or a map area with high skewness and may switch between the recognizers on the basis of the result of the determination. For example, the recognizer switching section 351 determines whether each pixel of the processing area belongs to the map area with low skewness or the map area with high skewness, and determines the map area to which more pixels belong as the map area to which the processing area belongs. In a case where the recognizer switching section 351 determines that the processing area belongs to the map area with low skewness, the recognizer switching section 351 switches to a recognizer that performs the recognition processing using a dictionary for low skewness that has learned using teacher images with low skewness. Therefore, in a case where the processing area is a low skewness area, it is possible to accurately recognize a subject in the processing area on the basis of the dictionary for low skewness using the image signals generated by the imaging section 20-1. Further, in a case where the recognizer switching section 351 determines that the processing area belongs to the map area with high skewness, the recognizer switching section 351 switches to a recognizer that performs the recognition processing using a dictionary for high skewness that has learned using teacher images with high skewness. Therefore, in a case where the processing area is a high skewness area, it is possible to accurately recognize a subject in the processing area on the basis of the dictionary for high skewness using the image signals generated by the imaging section 20-1.

In this manner, according to the first embodiment, the recognition processing is performed using a recognizer corresponding to an image characteristic of a processing area in an image obtained by the imaging section 20-1, that is, the optical characteristic of the imaging lens 21 used in the imaging section 20-1. Therefore, even if the use of the wide-angle lens or the cylindrical lens with a wider angle of view than the standard lens as the imaging lens causes differences in resolution or skewness in the image due to the optical characteristic of the imaging lens, the subject recognition can be performed using the recognizer corresponding to the processing area. This enables more accurate subject recognition than the case of using a recognizer that corresponds to, for example, the standard lens without switching between the recognizers.

### 2. Second Embodiment

In the case of performing subject recognition, for example, there is a case where it is sufficient to recognize a subject ahead and a case where it is desirable to be able to recognize not only the subject ahead but also a subject in a wide range. Each case can be handled by switching between imaging lenses and acquiring an image. According to a second embodiment, therefore, the subject recognition is accurately performed in a case where it is possible to switch between the imaging lenses.

<2-1. Configuration of Second Embodiment>

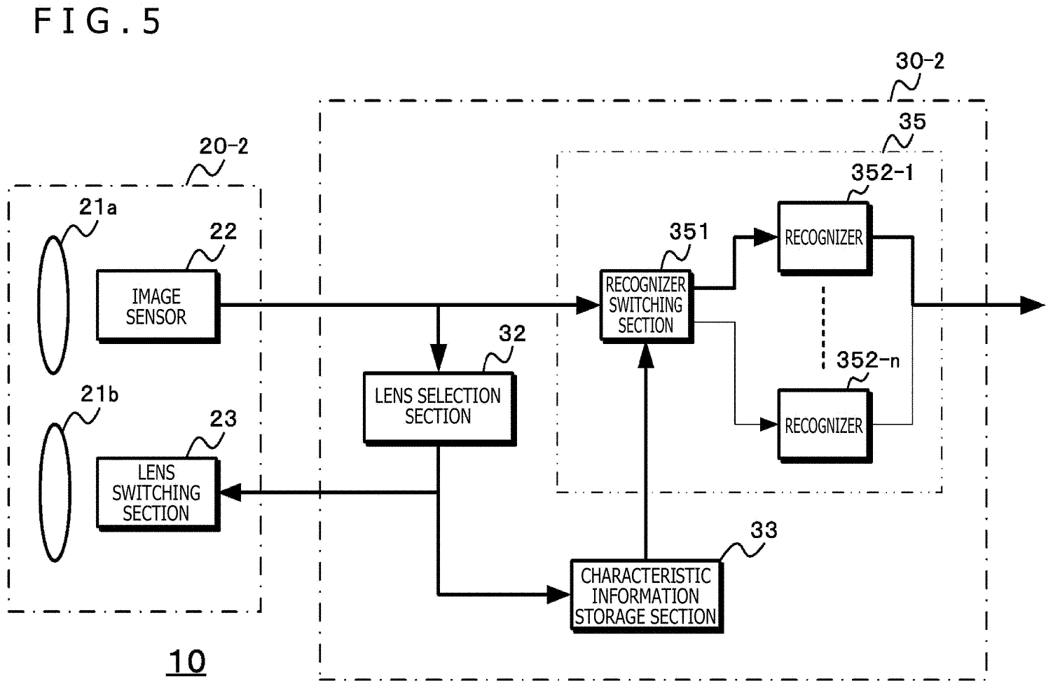

FIG. 5 exemplifies a configuration of the second embodiment. The imaging system 10 includes an imaging section 20-2 and an image processing section 30-2.

The imaging section 20-2 enables switching between a plurality of imaging lenses, for example, an imaging lens 21a and an imaging lens 21b, with different angles of view. The imaging lens 21a (21b) forms a subject optical image on an imaging surface of an image sensor 22 of the imaging section 20-2.

The image sensor 22 includes, for example, a CMOS (Complementary Metal Oxide Semiconductor) image sensor or a CCD (Charge Coupled Device) image. The image sensor 22 generates image signals corresponding to the subject optical image and outputs the image signals to the image processing section 30-2.

A lens switching section 23 switches the lens used for imaging to the imaging lens 21a or the imaging lens 21b on the basis of a lens selection signal supplied from a lens selection section 32 of the image processing section 30-2 described later.

The image processing section 30-2 performs subject recognition on the basis of the image signals generated by the imaging section 20-2. The image processing section 30-2 includes the lens selection section 32, a characteristic information storage section 33, the lens selection section 32, and the recognition processing section 35.

The lens selection section 32 performs scene determination and generates a lens selection signal for selecting an imaging lens with the angle of view suitable for the scene at the time of imaging. The lens selection section 32 performs the scene determination on the basis of image information, for example, an image obtained by the imaging section 20-2. Further, the lens selection section 32 may perform the scene determination on the basis of operation information and environment information of equipment including the imaging system 10. The lens selection section 32 outputs the generated lens selection signal to the lens switching section 23 of the imaging section 20-2 and the characteristic information storage section 33 of the image processing section 30-2.

The characteristic information storage section 33 stores, as characteristic information, a characteristic map based on an optical characteristic relevant to each imaging lens that can be used in the imaging section 20-2. For example, in a case where the imaging lens 21a and the imaging lens 21b are switchable in the imaging section 20-2, the characteristic information storage section 33 stores a characteristic map based on an optical characteristic of the imaging lens 21a and a characteristic map based on an optical characteristic of the imaging lens 21b. A resolution map, a skewness map, or the like is used as the characteristic information (characteristic map), for example. On the basis of the lens selection signal supplied from the lens selection section 32, the characteristic information storage section 33 outputs the characteristic information corresponding to the imaging lens used for imaging in the imaging section 20-2 to the recognition processing section 35.

The recognition processing section 35 includes a recognizer switching section 351 and a plurality of recognizers 352-1 to 352-n. For each imaging lens used in the imaging section 20-2, the recognizers 352-1 to 352-n are provided according to differences in optical characteristic of the imaging lens. Provided is the plurality of recognizers suitable for images with different resolutions, such as a recognizer suitable for an image with high resolution and a recognizer suitable for an image with low resolution, for example. The recognizer switching section 351 detects a processing area on the basis of the image signals generated by the imaging section 20-2. Further, the recognizer switching section 351 detects the resolution of the processing area on the basis of the position of the processing area on the image and the resolution map and switches the recognizer used for the subject recognition processing to a recognizer corresponding to the detected resolution. The recognizer switching section 351 supplies the image signals to the switched recognizer 352-x to recognize a subject in the processing area and output the result of the recognition from the image processing section 30-2.

Further, the recognizers 352-1 to 352-n may be provided according to the skewness of the imaging lens 21. Provided is the plurality of recognizers suitable for images with different skewness, such as a recognizer suitable for an image with small skewness and a recognizer suitable for an image with large skewness, for example. The recognizer switching section 351 detects a processing area on the basis of the image signals generated by the imaging section 20-2 and switches the recognizer used for the subject recognition processing to a recognizer corresponding to the detected skewness. The recognizer switching section 351 supplies the image signals to the switched recognizer 352-x to recognize a subject in the processing area and output the result of the recognition from the image processing section 30-2.

Further, for example, in a case where the recognition processing section 35 performs matching with a learned dictionary (e.g., a template) in subject recognition, the recognition processing section 35 may adjust the size and the amount of movement of the template so as to be able to obtain equivalent recognition accuracy regardless of differences in resolution and skewness.

<2-2. Operation of Second Embodiment>

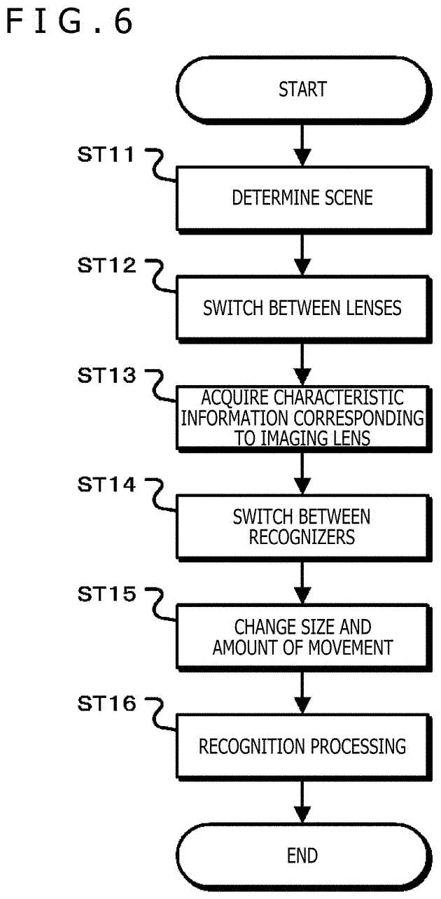

FIG. 6 is a flowchart exemplifying an operation of the second embodiment. In step ST11, the image processing section 30-2 performs scene determination. The lens selection section 32 of the image processing section 30-2 performs the scene determination. The lens selection section 32 determines an imaging scene on the basis of an image obtained by the imaging section 20-2 and an operation state and a usage state of the equipment including the imaging system 10, and proceeds to step ST12.

In step ST12, the image processing section 30-2 switches between the lenses. The lens selection section 32 of the image processing section 30-2 generates a lens selection signal such that an imaging lens with the angle of view suitable for the imaging scene determined in step ST12 is used in the imaging section 20-2. The lens selection section 32 outputs the generated lens selection signal to the imaging section 20-2 and proceeds to step ST13.

In step ST13, the image processing section 30-2 acquires characteristic information corresponding to the imaging lens. The lens selection section 32 of the image processing section 30-2 outputs the lens selection signal generated in step ST12 to the characteristic information storage section 33, and causes the characteristic information storage section 33 to output the characteristic information (characteristic map) based on an optical characteristic of the imaging lens used for imaging in the imaging section 20-2 to the recognition processing section 35. The recognition processing section 35 acquires the characteristic information supplied from the characteristic information storage section 33 and proceeds to step ST14.

In step ST14, the image processing section 30-2 switches between the recognizers. On the basis of the characteristic information acquired in step ST13, the recognition processing section 35 of the image processing section 30-2 switches to a recognizer corresponding to an image characteristic of a processing area in which the recognition processing is performed, and proceeds to step ST15.

In step ST15, the image processing section 30-2 changes the size and the amount of movement. When the recognition processing section 35 of the image processing section 30-2 performs subject recognition using the recognizer switched in step ST14, the recognition processing section 35 changes the size of the template and the amount of movement in the matching processing according to the image characteristic of the processing area and proceeds to step ST16.

The image processing section 30-2 performs the recognition processing in step ST16. By using the image signals generated by the imaging section 20-2, the recognition processing section 35 of the image processing section 30-2 performs the recognition processing using the recognizer switched in step ST14.

It is noted that the operation of the second embodiment is not limited to the operation illustrated in FIG. 6. For example, the recognition processing may be performed without performing the processing in step ST15.

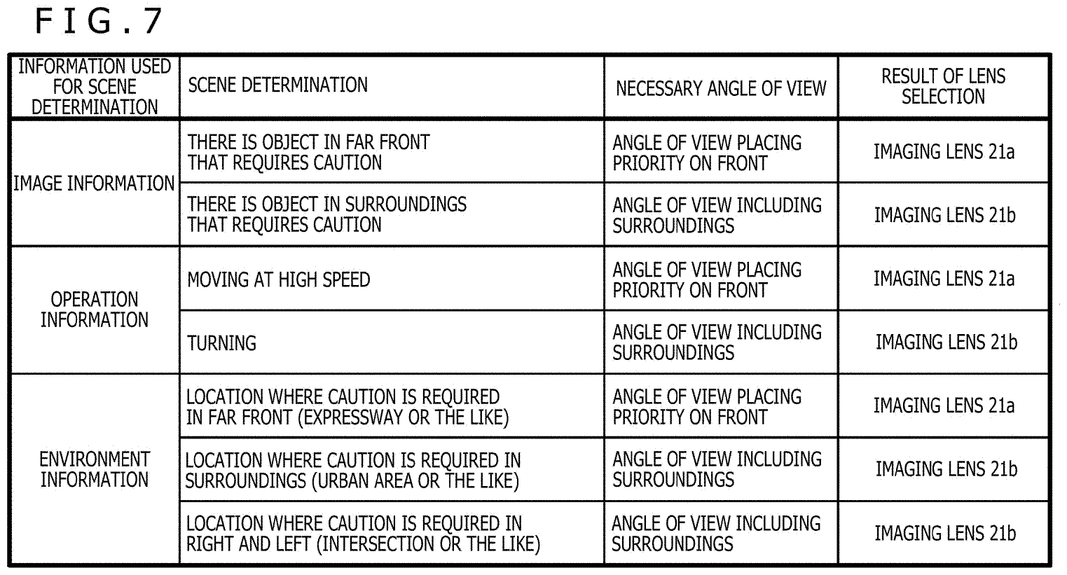

FIG. 7 is a diagram for describing the operation of the second embodiment. It is noted that the imaging lens 21b is an imaging lens with a wider angle of view than the imaging lens 21a.

In a case where the lens selection section 32 selects an imaging lens on the basis of image information, the lens selection section 32 determines whether the scene is, for example, where there is an object in the far front that requires caution or where there is an object in the surroundings that requires caution. In the scene where there is an object in the far front that requires caution, the lens selection section 32 selects the imaging lens 21a because of the need of the angle of view placing priority on the front. Further, in the scene where there is an object in the surroundings that requires caution, the lens selection section 32 selects the imaging lens 21b because of the need of the angle of view including the surroundings.

In a case where the lens selection section 32 selects an imaging lens on the basis of operation information (e.g., information indicating a movement of a vehicle including the imaging system), the lens selection section 32 determines whether the scene is, for example, where high-speed forward movement is occurring or where turning is being made. In the scene where high-speed forward movement is occurring, the lens selection section 32 selects the imaging lens 21a because of the need of the angle of view placing priority on the front. Further, in the scene where turning is being made, the lens selection section 32 selects the imaging lens 21b because of the need of the angle of view including the surroundings.

In a case where the lens selection section 32 selects an imaging lens on the basis of environment information (e.g., map information), the lens selection section 32 determines whether the scene is, for example, in an expressway or the like where caution is required in the far front, in an urban area or the like where caution is required in the surroundings, or in an intersection or the like where caution is required in the right and left. In the scene where caution is required in the far front, the lens selection section 32 selects the imaging lens 21a because of the need of the angle of view placing priority on the front. Further, in the scene where caution is required in the surroundings, the lens selection section 32 selects the imaging lens 21b because of the need of the angle of view including the surroundings. Moreover, in the scene where caution is required in the right and left, the lens selection section 32 selects the imaging lens 21b because of the need of the angle of view including the surroundings.

It is noted that the scene determination illustrated in FIG. 7 is an example, and the imaging lens may be selected on the basis of the scene determination result that is not illustrated in FIG. 7. Further, although FIG. 7 illustrates a case where there are two types of imaging lenses that can be switched, three or more types of imaging lenses may be switched on the basis of the scene determination result. Further, the imaging lens may be selected on the basis of a plurality of scene determination results. In this case, in a case where the necessary angle of view differs, the imaging lenses are switched according to reliability of the scene determination results. For example, in a case where the necessary angle of view differs between the scene determination result of the operation information and the scene determination result of the environment information and the reliability of the scene determination result is low since the vehicle is moving slowly or a steering angle is small, the imaging lens is selected using the scene determination result of the environment information.

In this manner, according to the second embodiment, even in a case where the imaging lenses with different angles of view are switched and used according to an image characteristic of a processing area in an image obtained by the imaging section 20-2, that is, an imaging scene, the recognition processing is performed using a recognizer corresponding to the image characteristic of the processing area in the characteristic map based on the optical characteristic of the imaging lens used for imaging in the imaging section 20-2. Therefore, even if switching is performed between the standard lens and the wide-angle lens or the cylindrical lens with a wide angle of view according to the imaging scene and differences in resolution or skewness occur in the image due to the optical characteristic of the imaging lens used at the time of imaging, the subject recognition can be performed using the recognizer corresponding to the processing area. This enables more accurate subject recognition than the case of not switching between the recognizers.

### 3. Third Embodiment

Incidentally, in some cases, the resolution of an image obtained by the imaging section generates an area with high resolution and an area with low resolution depending on the configuration of the image sensor. For example, in a case where a color filter is not used in the image sensor, it is possible to acquire an image with higher resolution than a case where the color filter is used. Therefore, in a case where the image sensor is configured so as not to arrange the color filter in an area where an image with high resolution is needed, it is possible to acquire an image that includes a black and white image area with high resolution and a color image area with low resolution. According to a third embodiment, therefore, the subject recognition is accurately performed even in the case of using an image sensor that can acquire an image whose characteristic differs depending on the area.

<3-1. Configuration of Third Embodiment>

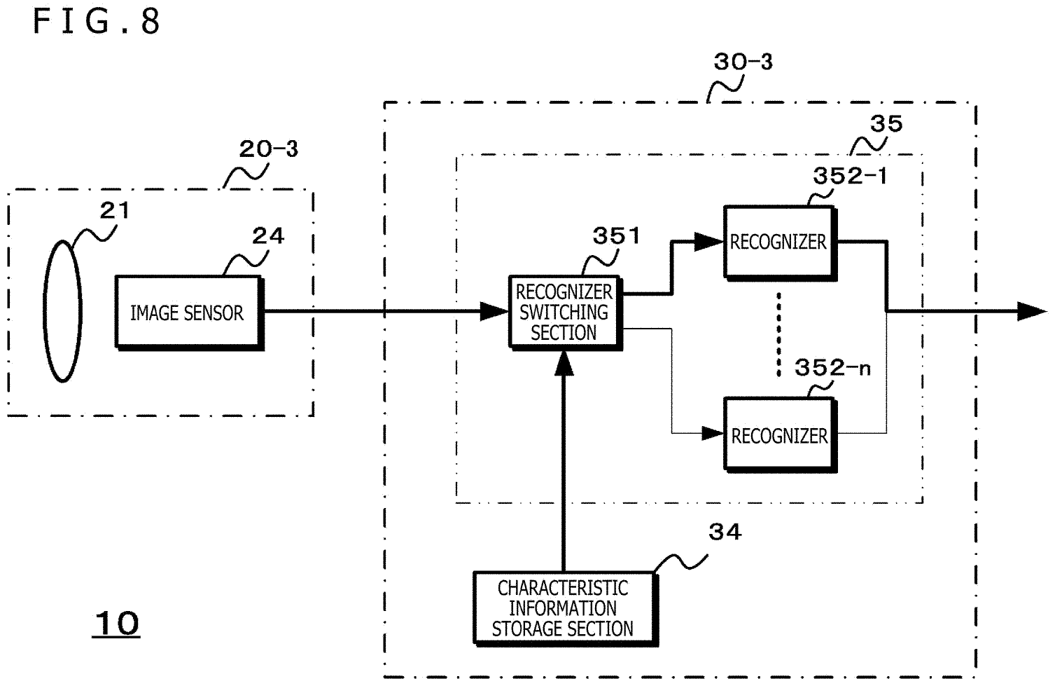

FIG. 8 exemplifies a configuration of the third embodiment. The imaging system 10 includes an imaging section 20-3 and an image processing section 30-3.

An imaging lens 21 of the imaging section 20-3 forms a subject optical image on an imaging surface of an image sensor 24 of the imaging section 20-3.

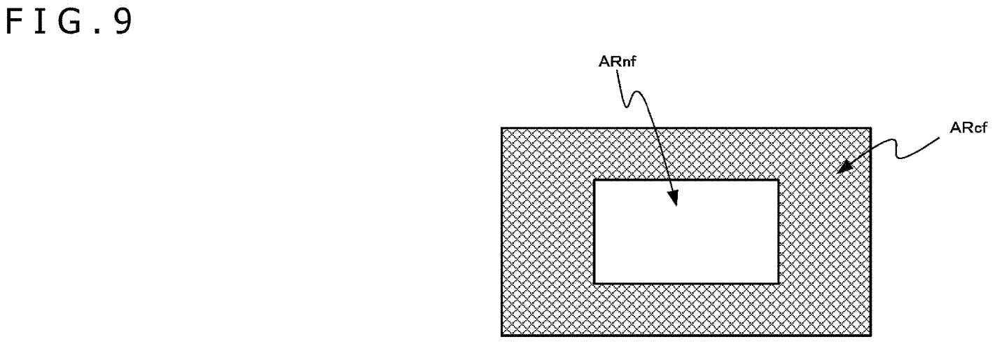

The image sensor 24 includes, for example, a CMOS (Complementary Metal Oxide Semiconductor) image sensor or a CCD (Charge Coupled Device) image. Further, the image sensor 24 uses a color filter, and a part of the imaging surface includes an area in which the color filter is not arranged. For example, FIG. 9 exemplifies the imaging surface of the image sensor. A rectangular map area ARnf located in a center is an area in which the color filter is not arranged, and another map area ARcf denoted by cross-hatching is an area in which the color filter is arranged. The image sensor 24 generates image signals corresponding to the subject optical image and outputs the image signals to the image processing section 30-3.

The image processing section 30-3 performs subject recognition on the basis of the image signals generated by the imaging section 20-3. The image processing section 30-3 includes a characteristic information storage section 34 and a recognition processing section 35.

The characteristic information storage section 34 stores, as characteristic information, a characteristic map based on filter arrangement in the image sensor 24 of the imaging section 20-3. A color pixel map in which color pixels and non-color pixels can be distinguished from each other is used as the characteristic map, for example. The characteristic information storage section 34 outputs the stored characteristic information to the recognition processing section 35.

The recognition processing section 35 includes a recognizer switching section 351 and a plurality of recognizers 352-1 to 352-n. The recognizers 352-1 to 352-n are provided according to the filter arrangement in the image sensor 24 of the imaging section 20-3. Provided is the plurality of recognizers suitable for images with different resolutions, such as a recognizer suitable for an image with high resolution and a recognizer suitable for an image with low resolution, for example. The recognizer switching section 351 detects a processing area on the basis of the image signals generated by the imaging section 20-3. Further, the recognizer switching section 351 switches between the recognizers used for the subject recognition processing on the basis of the position of the processing area on the image and the characteristic information. The recognizer switching section 351 supplies the image signals to the switched recognizer 352-x to recognize a subject in the processing area and outputs the result of the recognition from the image processing section 30-3.

Further, for example, in a case where the recognition processing section 35 performs matching with a learned dictionary (e.g., a template) in subject recognition, the recognition processing section 35 may adjust the size and the amount of movement of the template so as to be able to obtain equivalent recognition accuracy regardless of differences in resolution and skewness.

<3-2. Operation of Third Embodiment>

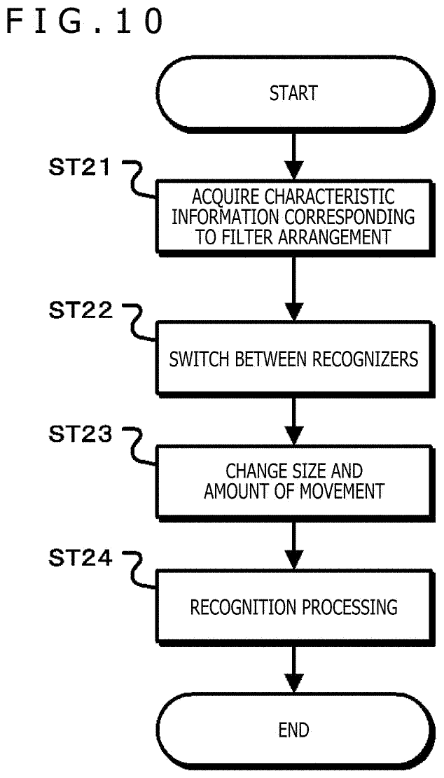

FIG. 10 is a flowchart exemplifying an operation of the third embodiment. In step ST21, the image processing section 30-3 acquires characteristic information corresponding to the filter arrangement. The recognition processing section 35 of the image processing section 30-3 acquires the characteristic information (characteristic map) based on a filter arrangement state of the image sensor 22 used in the imaging section 20-3 and proceeds to step ST22.

In step ST22, the image processing section 30-3 switches between the recognizers. On the basis of the characteristic information acquired in step ST21, the recognition processing section 35 of the image processing section 30-3 switches to a recognizer corresponding to an image characteristic of a processing area in which the recognition processing is performed, and proceeds to step ST23.

In step ST23, the image processing section 30-3 changes the size and the amount of movement. When the recognition processing section 35 of the image processing section 30-3 performs subject recognition using the recognizer switched in step ST22, the image processing section 30-3 changes the size of the template and the amount of movement in the matching processing according to the image characteristic of the processing area and proceeds to step ST24.

The image processing section 30-3 performs the recognition processing in step ST24. By using the image signals generated by the imaging section 20-3, the recognition processing section 35 of the image processing section 30-3 performs the recognition processing using the recognizer switched in step ST22.

It is noted that the operation of the third embodiment is not limited to the operation illustrated in FIG. 10. For example, the recognition processing may be performed without performing the processing in step ST23.

Next, an example of the operation of the third embodiment will be described. For example, the recognition processing section 35 includes the recognizer 352-1 and the recognizer 352-2. The recognizer 352-1 performs recognition processing using a dictionary for high resolution that has learned using teacher images captured without using the color filter. The recognizer 352-2 performs recognition processing using a dictionary for low resolution that has learned using teacher images captured using the color filter.

The recognizer switching section 351 of the recognition processing section 35 performs similar processing to that of the above-described first embodiment to determine whether the processing area in which the recognition processing is performed belongs to the map area ARnf or the map area ARcf. The map area ARnf is an area in which the color filter is not arranged. The map area ARcf is an area in which the color filter is arranged. In a case where the recognizer switching section 351 determines that the processing area belongs to the map area ARh, the recognizer switching section 351 switches to the recognizer 352-1. Therefore, in a case where the processing area is a high resolution area, it is possible to accurately recognize a subject in the processing area on the basis of the dictionary for high resolution using the image signals generated by the imaging section 20-3. Further, in a case where the recognizer switching section 351 determines that the processing area belongs to the map area ARcf, the recognizer switching section 351 switches to the recognizer 352-2. Therefore, in a case where the processing area is a low resolution area, it is possible to accurately recognize a subject in the processing area on the basis of the dictionary for low resolution using the image signals generated by the imaging section 20-3.

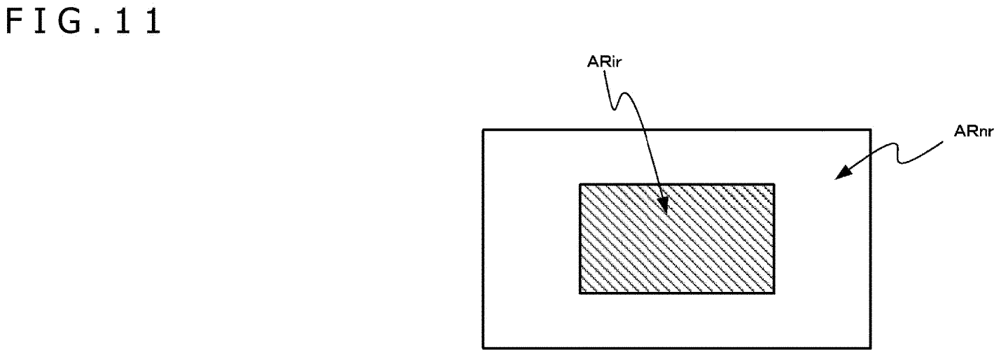

Further, although the operation described above assumes the case where the area in which the color filter is arranged and the area in which the color filter is not arranged are provided, an area in which an IR filter that removes infrared rays is arranged and an area in which the IR filter is not arranged may be provided. FIG. 11 exemplifies the imaging surface of an image sensor. A rectangular map area ARir located in a center and denoted by diagonal lines is an area in which the IR filter is arranged, and another map area ARnr is an area in which the IR filter is not arranged. In a case where the image sensor 24 is configured in this manner, the map area ARnr, in which the IR filter is not arranged, becomes more sensitive than the map area ARir, in which the IR filter is arranged. Therefore, the recognizer switching section 351 of the recognition processing section 35 determines whether the processing area in which the recognition processing is performed belongs to the map area ARnr, in which the IR filter is not arranged, or the map area ARir, in which the IR filter is arranged.

In a case where the recognizer switching section 351 determines that the processing area belongs to the map area ARnr, the recognizer switching section 351 switches to a recognizer that performs the recognition processing using a dictionary for high sensitivity. Therefore, in a case where the processing area is located in the map area ARnr, it is possible to accurately recognize a subject in the processing area on the basis of the dictionary for high sensitivity using the image signals generated by the imaging section 20-3. Further, in a case where the recognizer switching section 351 determines that the processing area belongs to the map area ARir, the recognizer switching section 351 switches to a recognizer that performs the recognition processing using a dictionary for low sensitivity. Therefore, in a case where the processing area is located in the map area ir, it is possible to accurately recognize a subject in the processing area on the basis of the dictionary for low sensitivity using the image signals generated by the imaging section 20-3.

In this manner, according to the third embodiment, the recognition processing is performed using a recognizer corresponding to an image characteristic of a processing area in an image obtained by the imaging section 20-3, that is, the filter arrangement state of the image sensor 24 used in the imaging section 20-3. Therefore, even in a case where the filter arrangement causes differences in resolution in the image, the subject recognition can be performed using the recognizer corresponding to the processing area. This enables more accurate subject recognition than the case of not switching between the recognizers.

### 4. Modifications

In the present technology, the above-described embodiments may be combined. For example, combining the first embodiment and the third embodiment can widen a range of the angle of view in which the color filter is arranged or a range of the angle of view in which the IR filter is not arranged. Further, the second embodiment and the third embodiment may also be combined. It is noted that, in a case where the embodiments are combined, it is possible to recognize a subject more accurately by performing the recognition processing by switching to a recognizer corresponding to a combination of the optical characteristic and the filter arrangement.

Further, the characteristic map may be stored in the imaging section, or the image processing section may generate the characteristic map by acquiring, from the imaging section, information indicating the optical characteristic of the imaging lens or the filter arrangement of the image sensor. Such a configuration can accommodate changes in the imaging section, the imaging lens, or the image sensor.

### 5. Application Examples

The technology according to the present disclosure can be applied to various types of products. For example, the technology according to the present disclosure may be implemented as an apparatus to be mounted in any type of mobile object such as an automobile, an electric vehicle, a hybrid electric vehicle, a motorcycle, a bicycle, personal mobility, an airplane, a drone, a ship, a robot, a construction machine, or an agricultural machine (tractor).

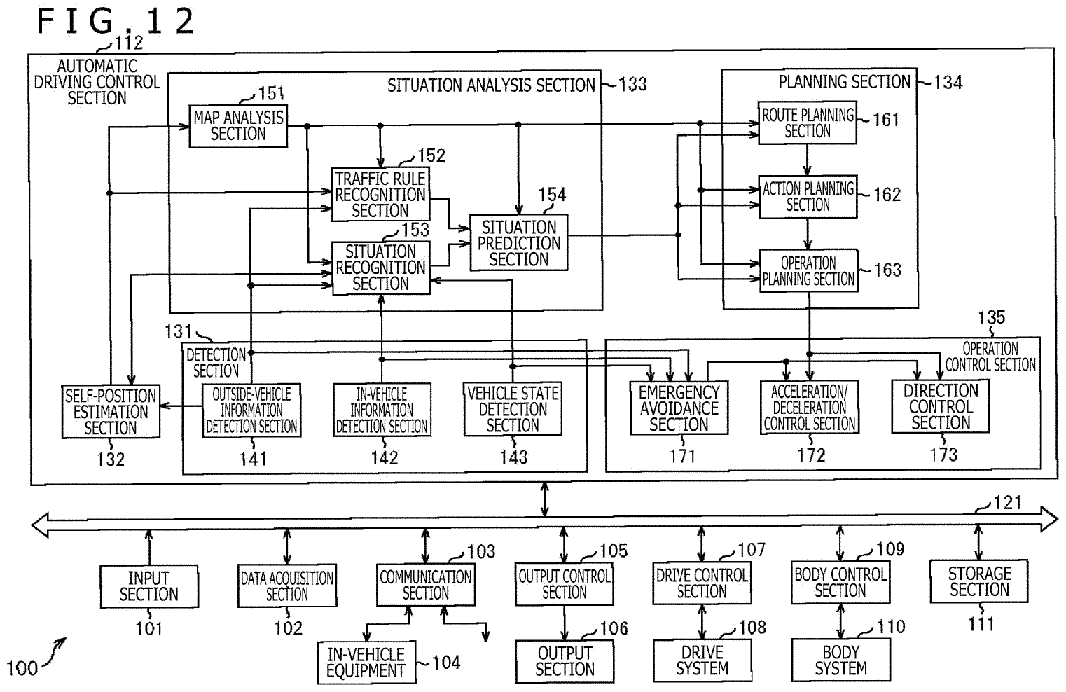

FIG. 12 is a block diagram illustrating an example of a schematic functional configuration of a vehicle control system 100 as an example of a mobile object control system to which the present technology can be applied.

It is noted that hereinafter, in a case where a vehicle including the vehicle control system 100 is distinguished from other vehicles, the vehicle will be referred to as a host car or a host vehicle.

The vehicle control system 100 includes an input section 101, a data acquisition section 102, a communication section 103, in-vehicle equipment 104, an output control section 105, an output section 106, a drive control section 107, a drive system 108, a body control section 109, a body system 110, a storage section 111, and an automatic driving control section 112. The input section 101, the data acquisition section 102, the communication section 103, the output control section 105, the drive control section 107, the body control section 109, the storage section 111, and the automatic driving control section 112 are interconnected through a communication network 121. For example, the communication network 121 includes a vehicle-mounted communication network, a bus, and the like that conform to an optional standard such as a CAN (Controller Area Network), a LIN (Local Interconnect Network), a LAN (Local Area Network), or FlexRay (registered trademark). It is noted that each section of the vehicle control system 100 may be, in some cases, directly connected without the communication network 121.

It is noted that hereinafter, in a case where each section of the vehicle control system 100 performs communication through the communication network 121, the description of the communication network 121 will be omitted. For example, in a case where the input section 101 and the automatic driving control section 112 communicate with each other through the communication network 121, it will be simply described that the input section 101 and the automatic driving control section 112 communicate with each other.

The input section 101 includes an apparatus that is used by an occupant to input various types of data, instructions, and the like. For example, the input section 101 includes operation devices such as a touch panel, a button, a microphone, a switch, and a lever, an operation device that can perform an input by voice, gesture, or the like, which is a method other than a manual operation, and the like. Further, for example, the input section 101 may be a remote control apparatus using infrared rays or other radio waves, or may be external connection equipment such as mobile equipment or wearable equipment that supports the operation of the vehicle control system 100. The input section 101 generates an input signal on the basis of data, instructions, and the like input by an occupant, and supplies the input signal to each section of the vehicle control system 100.

The data acquisition section 102 includes various types of sensors and the like that acquire data to be used for processing in the vehicle control system 100, and supplies the acquired data to each section of the vehicle control system 100.

For example, the data acquisition section 102 includes various types of sensors for detecting a state and the like of the host car. Specifically, the data acquisition section 102 includes, for example, a gyro sensor, an acceleration sensor, an inertial measurement unit (IMU), and sensors for detecting an amount of operation of an accelerator pedal, an amount of operation of a brake pedal, a steering angle of a steering wheel, an engine speed, a motor speed, a rotational speed of wheels, or the like.

Further, for example, the data acquisition section 102 includes various types of sensors for detecting information regarding an outside of the host car. Specifically, the data acquisition section 102 includes, for example, imaging apparatuses such as a ToF (Time Of Flight) camera, a stereo camera, a monocular camera, an infrared camera, and other cameras. Further, the data acquisition section 102 includes, for example, an environment sensor for detecting weather, meteorological phenomenon, or the like, and a surrounding information detection sensor for detecting objects in the surroundings of the host car. The environment sensor includes, for example, a raindrop sensor, a fog sensor, a sunshine sensor, a snow sensor, and the like. The surrounding information detection sensor includes, for example, an ultrasonic sensor, a radar, LiDAR (Light Detection and Ranging, Laser Imaging Detection and Ranging), a sonar, and the like.

Moreover, for example, the data acquisition section 102 includes various types of sensors for detecting a current position of the host car. Specifically, the data acquisition section 102 includes, for example, a GNSS (Global Navigation Satellite System) receiver and the like. The GNSS receiver receives a GNSS signal from a GNSS satellite.

Further, for example, the data acquisition section 102 includes various types of sensors for detecting in-vehicle information. Specifically, the data acquisition section 102 includes, for example, an imaging apparatus that captures a driver, a biosensor that detects biological information regarding the driver, a microphone that collects sound in the vehicle interior, and the like. For example, the biosensor is provided in a seat surface, the steering wheel, or the like and detects biological information regarding an occupant sitting on a seat or the driver holding the steering wheel.

The communication section 103 communicates with the in-vehicle equipment 104, various types of outside-vehicle equipment, a server, a base station, and the like to transmit data supplied from each section of the vehicle control system 100 and supply received data to each section of the vehicle control system 100. It is noted that there is no particular limitation to a communication protocol supported by the communication section 103 and the communication section 103 can support a plurality of types of communication protocols.

For example, the communication section 103 performs wireless communication with the in-vehicle equipment 104 using a wireless LAN, Bluetooth (registered trademark), NFC (Near Field Communication), WUSB (Wireless USB), or the like. Further, for example, the communication section 103 performs wired communication with the in-vehicle equipment 104 using a USB (Universal Serial Bus), an HDMI (registered trademark) (High-Definition Multimedia Interface), an MHL (Mobile High-definition Link), or the like through a connection terminal (and a cable if necessary), not illustrated.

Moreover, for example, the communication section 103 communicates with equipment (e.g., an application server or a control server) that is present on an external network (e.g., the Internet, a cloud network, or an operator-specific network) through a base station or an access point. Further, for example, the communication section 103 communicates with a terminal (e.g., a terminal of a pedestrian or a store, or an MTC (Machine Type Communication) terminal) that is present in a vicinity of the host car using a P2P (Peer To Peer) technology. Moreover, for example, the communication section 103 performs V2X communication such as communication between a vehicle and a vehicle (Vehicle to Vehicle), communication between a vehicle and infrastructure (Vehicle to Infrastructure), communication between the host car and a home (Vehicle to Home), and communication between a vehicle and a pedestrian (Vehicle to Pedestrian). Further, for example, the communication section 103 includes a beacon reception section to receive radio waves or electromagnetic waves transmitted from wireless stations or the like installed on roads and acquire information regarding the current position, traffic congestion, traffic regulation, necessary time, or the like.

The in-vehicle equipment 104 includes, for example, mobile equipment or wearable equipment owned by an occupant, information equipment carried into or attached to the host car, a navigation apparatus that searches for a route to a desired destination, and the like.

The output control section 105 controls output of various types of information to an occupant or the outside of the host car. For example, the output control section 105 generates an output signal including at least one of visual information (e.g., image data) or auditory information (e.g., sound data) and supplies the output signal to the output section 106 to control the output of the visual information and the auditory information from the output section 106. Specifically, for example, the output control section 105 combines image data captured by different imaging apparatuses of the data acquisition section 102 to generate a bird's-eye view image, a panoramic image, or the like, and supplies an output signal including the generated image to the output section 106. Further, for example, the output control section 105 generates sound data including a warning sound, a warning message, or the like regarding danger such as a collision, a contact, an entry into a dangerous zone, or the like, and supplies an output signal including the generated sound data to the output section 106.

The output section 106 includes an apparatus capable of outputting the visual information or the auditory information to an occupant or the outside of the host car. The output section 106 includes, for example, a display apparatus, an instrument panel, an audio speaker, headphones, a wearable device such as an eyeglass-type display worn by an occupant, a projector, a lamp, and the like. In addition to an apparatus with a general display, the display apparatus included in the output section 106 may be, for example, an apparatus, such as a head-up display, a transmissive display, or an apparatus with an AR (Augmented Reality) display function, that displays the visual information in the driver's field of view.

The drive control section 107 controls the drive system 108 by generating various types of control signals and supplying the control signals to the drive system 108. Further, the drive control section 107 supplies the control signals to each section other than the drive system 108 as necessary to notify each section of a control state of the drive system 108, for example.

The drive system 108 includes various types of apparatuses related to the drive system of the host car. The drive system 108 includes, for example, a drive force generation apparatus, a drive force transmission mechanism, a steering mechanism, a braking apparatus, an ABS (Antilock Brake System), ESC (Electronic Stability Control), an electric power steering apparatus, and the like. The drive force generation apparatus generates a drive force of an internal combustion engine, a drive motor, or the like. The drive force transmission mechanism transmits the drive force to wheels. The steering mechanism adjusts a steering angle. The braking apparatus generates a braking force.

The body control section 109 controls the body system 110 by generating various types of control signals and supplying the control signals to the body system 110. Further, the body control section 109 supplies the control signals to each section other than the body system 110 as necessary to notify each section of a control state of the body system 110, for example.

The body system 110 includes various types of apparatuses of the body system mounted in the vehicle body. For example, the body system 110 includes a keyless entry system, a smart key system, a power window apparatus, a power seat, the steering wheel, an air conditioning apparatus, various types of lamps (e.g., headlamps, tail lamps, brake lamps, turn signals, fog lamps, and the like), and the like.

The storage section 111 includes, for example, a ROM (Read Only Memory), a RAM (Random Access Memory), a magnetic storage device such as an HDD (Hard Disc Drive), a semiconductor storage device, an optical storage device, a magneto-optical storage device, and the like. The storage section 111 stores various types of programs, data, and the like used by each section of the vehicle control system 100. For example, the storage section 111 stores map data such as a three-dimensional high-accuracy map such as a dynamic map, a global map that is less accurate than the high-accuracy map and covers a wide area, and a local map that includes information regarding the surroundings of the host car.

The automatic driving control section 112 performs control related to automatic driving such as autonomous travel or driving support. Specifically, for example, the automatic driving control section 112 performs cooperative control intended to implement functions of an ADAS (Advanced Driver Assistance System) which include collision avoidance or shock mitigation for the host car, following travel based on a following distance, vehicle speed maintaining travel, a warning of collision of the host car, a warning of deviation of the host car from a lane, or the like. Further, for example, the automatic driving control section 112 performs cooperative control intended for automatic driving, which allows autonomous travel without depending on the operation of the driver, or the like. The automatic driving control section 112 includes a detection section 131, a self-position estimation section 132, a situation analysis section 133, a planning section 134, and an operation control section 135.

The detection section 131 detects various types of information necessary to control automatic driving. The detection section 131 includes an outside-vehicle information detection section 141, an in-vehicle information detection section 142, and a vehicle state detection section 143.

The outside-vehicle information detection section 141 performs processing of detecting information regarding the outside of the host car on the basis of data or signals from each section of the vehicle control system 100. For example, the outside-vehicle information detection section 141 performs processing of detecting, recognizing, and tracking objects in the surroundings of the host car and processing of detecting distances to the objects. The objects to be detected include, for example, vehicles, humans, obstacles, structures, roads, traffic lights, traffic signs, road markings, and the like. Further, for example, the outside-vehicle information detection section 141 performs processing of detecting an environment in the surroundings of the host car. The surrounding environment to be detected includes, for example, weather, temperature, humidity, brightness, road surface conditions, and the like. The outside-vehicle information detection section 141 supplies data indicating the detection processing result to the self-position estimation section 132, a map analysis section 151, a traffic rule recognition section 152, and a situation recognition section 153 of the situation analysis section 133, an emergency avoidance section 171 of the operation control section 135, and the like.

The in-vehicle information detection section 142 performs processing of detecting in-vehicle information on the basis of data or signals from each section of the vehicle control system 100. For example, the in-vehicle information detection section 142 performs processing of authenticating and recognizing the driver, processing of detecting the state of the driver, processing of detecting an occupant, processing of detecting an in-vehicle environment, and the like. The state of the driver to be detected includes, for example, physical conditions, an arousal level, a concentration level, a fatigue level, a line-of-sight direction, and the like. The in-vehicle environment to be detected includes, for example, temperature, humidity, brightness, odor, and the like. The in-vehicle information detection section 142 supplies data indicating the detection processing result to the situation recognition section 153 of the situation analysis section 133, the emergency avoidance section 171 of the operation control section 135, and the like.

The vehicle state detection section 143 performs processing of detecting the state of the host car on the basis of data or signals from each section of the vehicle control system 100. The state of the host car to be detected includes, for example, a speed, an acceleration, a steering angle, presence/absence and contents of abnormality, a state of driving operation, a position and an inclination of the power seat, a state of a door lock, a state of other vehicle-mounted equipment, and the like. The vehicle state detection section 143 supplies data indicating the detection processing result to the situation recognition section 153 of the situation analysis section 133, the emergency avoidance section 171 of the operation control section 135, and the like.

The self-position estimation section 132 performs processing of estimating a position, an attitude, and the like of the host car on the basis of data or signals from each section of the vehicle control system 100 such as the outside-vehicle information detection section 141 and the situation recognition section 153 of the situation analysis section 133. Further, the self-position estimation section 132 generates a local map (hereinafter referred to as a self-position estimation map) that is used to estimate the self position, as necessary. For example, the self-position estimation map is a high-accuracy map using a technique such as SLAM (Simultaneous Localization and Mapping). The self-position estimation section 132 supplies data indicating the estimation processing result to the map analysis section 151, the traffic rule recognition section 152, and the situation recognition section 153 of the situation analysis section 133, and the like. Further, the self-position estimation section 132 causes the storage section 111 to store the self-position estimation map.

The situation analysis section 133 performs processing of analyzing a situation of the host car and the surroundings. The situation analysis section 133 includes the map analysis section 151, the traffic rule recognition section 152, the situation recognition section 153, and a situation prediction section 154.

The map analysis section 151 performs processing of analyzing various types of maps stored in the storage section 111 by using data or signals from each section of the vehicle control system 100 such as the self-position estimation section 132 and the outside-vehicle information detection section 141 as necessary and creates a map including information necessary to process automatic driving. The map analysis section 151 supplies the created map to the traffic rule recognition section 152, the situation recognition section 153, the situation prediction section 154, a route planning section 161, an action planning section 162, and an operation planning section 163 of the planning section 134, and the like.

The traffic rule recognition section 152 performs processing of recognizing traffic rules in the surroundings of the host car on the basis of data or signals from each section of the vehicle control system 100 such as the self-position estimation section 132, the outside-vehicle information detection section 141, and the map analysis section 151. Through the recognition processing, a position and a state of a traffic light in the surroundings of the host car, contents of traffic regulations in the surroundings of the host car, a travelable lane, and the like are recognized, for example. The traffic rule recognition section 152 supplies data indicating the recognition processing result to the situation prediction section 154 and the like.

The situation recognition section 153 performs processing of recognizing a situation related to the host car on the basis of data or signals from each section of the vehicle control system 100 such as the self-position estimation section 132, the outside-vehicle information detection section 141, the in-vehicle information detection section 142, the vehicle state detection section 143, and the map analysis section 151. For example, the situation recognition section 153 performs processing of recognizing a situation of the host car, a situation in the surroundings of the host car, a situation of the driver of the host car, and the like. Further, the situation recognition section 153 generates a local map (hereinafter referred to as a situation recognition map) that is used to recognize the situation in the surroundings of the host car, as necessary. The situation recognition map is, for example, an occupancy grid map.

The situation of the host car to be recognized includes, for example, the position, attitude, and movement (e.g., speed, acceleration, a moving direction, and the like) of the host car, the presence/absence and contents of abnormality, and the like. The situation in the surroundings of the host car to be recognized includes, for example, types and positions of stationary objects in the surroundings, types, positions, and movement (e.g., speed, acceleration, a moving direction, and the like) of moving objects in the surroundings, road structure and road surface conditions in the surroundings, the weather, temperature, humidity, and brightness in the surroundings, and the like. The state of the driver to be recognized includes, for example, physical conditions, the arousal level, the concentration level, the fatigue level, movement of the line of sight, driving operation, and the like.

The situation recognition section 153 supplies data indicating the recognition processing result (including the situation recognition map, as necessary) to the self-position estimation section 132, the situation prediction section 154, and the like. Further, the situation recognition section 153 causes the storage section 111 to store the situation recognition map.

The situation prediction section 154 performs processing of predicting the situation related to the host car on the basis of data or signals from each section of the vehicle control system 100 such as the map analysis section 151, the traffic rule recognition section 152, and the situation recognition section 153. For example, the situation prediction section 154 performs processing of predicting the situation of the host car, the situation in the surroundings of the host car, the situation of the driver, and the like.

The situation of the host car to be predicted includes, for example, a behavior of the host car, an occurrence of abnormality, mileage, and the like. The situation in the surroundings of the host car to be predicted includes, for example, a behavior of moving objects in the surroundings of the host car, a change in the state of a traffic light, a change in the environment such as weather, and the like. The situation of the driver to be predicted includes, for example, a behavior, physical conditions, and the like of the driver.

The situation prediction section 154 supplies data indicating the prediction processing result, together with data from the traffic rule recognition section 152 and the situation recognition section 153, to the route planning section 161, the action planning section 162, and the operation planning section 163 of the planning section 134, and the like.

The route planning section 161 plans a route to a destination on the basis of data or signals from each section of the vehicle control system 100 such as the map analysis section 151 and the situation prediction section 154. For example, the route planning section 161 sets a route from the current position to a specified destination on the basis of the global map. Further, for example, the route planning section 161 appropriately changes the route on the basis of situations of traffic congestion, accidents, traffic regulations, construction, and the like, physical conditions of the driver, and the like. The route planning section 161 supplies data indicating the planned route to the action planning section 162 and the like.

The action planning section 162 plans action of the host car for safely traveling the route planned by the route planning section 161 within a planned time period on the basis of data or signals from each section of the vehicle control system 100 such as the map analysis section 151 and the situation prediction section 154. For example, the action planning section 162 makes a plan for a start, a stop, a traveling direction (e.g., forward, backward, left turn, right turn, direction change, or the like), a traveling lane, a traveling speed, overtaking, and the like. The action planning section 162 supplies data indicating the planned action of the host car to the operation planning section 163 and the like.

The operation planning section 163 plans the operation of the host car for performing the action planned by the action planning section 162 on the basis of data or signals from each section of the vehicle control system 100 such as the map analysis section 151 and the situation prediction section 154. For example, the operation planning section 163 makes a plan for an acceleration, a deceleration, a traveling trajectory, and the like. The operation planning section 163 supplies data indicating the planned operation of the host car to an acceleration/deceleration control section 172 and a direction control section 173 of the operation control section 135, and the like.

The operation control section 135 controls the operation of the host car. The operation control section 135 includes the emergency avoidance section 171, the acceleration/deceleration control section 172, and the direction control section 173.

The emergency avoidance section 171 performs processing of detecting an emergency such as a collision, a contact, an entry into a dangerous zone, abnormality of the driver, abnormality of the vehicle, and the like on the basis of the detection results of the outside-vehicle information detection section 141, the in-vehicle information detection section 142, and the vehicle state detection section 143. In a case where the emergency avoidance section 171 detects an occurrence of an emergency, the emergency avoidance section 171 plans the operation of the host car such as a sudden stop or a sharp turn to avoid the emergency. The emergency avoidance section 171 supplies data indicating the planned operation of the host car to the acceleration/deceleration control section 172, the direction control section 173, and the like.

The acceleration/deceleration control section 172 performs acceleration/deceleration control for performing the operation of the host car planned by the operation planning section 163 or the emergency avoidance section 171. For example, the acceleration/deceleration control section 172 calculates a control target value of the drive force generation apparatus or the braking apparatus for performing the planned acceleration, deceleration, or sudden stop and supplies a control command indicating the calculated control target value to the drive control section 107.

The direction control section 173 performs direction control for performing the operation of the host car planned by the operation planning section 163 or the emergency avoidance section 171. For example, the direction control section 173 calculates a control target value of the steering mechanism for making the traveling trajectory or sharp turn planned by the operation planning section 163 or the emergency avoidance section 171 and supplies a control command indicating the calculated control target value to the drive control section 107.

In the vehicle control system 100 described above, the imaging section 20-1 (20-2, 20-3) described in the present embodiment corresponds to the data acquisition section 102, and the image processing section 30-1 (30-2, 30-3) corresponds to the outside-vehicle information detection section 141. In a case where the imaging section 20-1 and the image processing section 30-1 are provided in the vehicle control system 100 and the wide-angle lens or the cylindrical lens with a wider angle of view than the standard lens is used as the imaging lens, subject recognition can be performed using a recognizer corresponding to the optical characteristic of the imaging lens. Therefore, it is possible to accurately recognize not only a subject in front of the vehicle but also a subject in the surroundings.

Further, in a case where the imaging section 20-2 and the image processing section 30-2 are provided in the vehicle control system 100, the imaging lenses with different angles of view can be switched according to an imaging scene on the basis of operation information or surrounding information of the vehicle or image information acquired by the imaging section, and subject recognition can be performed using a recognizer corresponding to the optical characteristic of the imaging lens used for imaging. Therefore, it is possible to accurately recognize a subject within the angle of view suitable for the traveling state of the vehicle.

Moreover, in a case where the imaging section 20-3 and the image processing section 30-3 are provided in the vehicle control system 100, subject recognition can be performed using a recognizer corresponding to the configuration of the image sensor. For example, even in a case where there is an area in which the color filter is not arranged in a central portion of the imaging surface in the image sensor in order to perform subject processing placing priority on the far front, recognition processing can be performed by switching between a recognizer suitable for an area in which the color filter is arranged and a recognizer suitable for the area in which the color filter is not arranged. Therefore, even in a case where the image sensor is configured to obtain an image suitable for travel control of the vehicle, recognition processing can be accurately performed using a recognizer corresponding to the configuration of the image sensor. Further, in a case where the image sensor is configured to be able to detect a red subject in a central portion to recognize a traffic light or a sign, for example, subject recognition can be accurately performed by using a recognizer suitable for recognizing the red subject in the central portion.

Further, in a case where a vehicle travels with headlights turned on, the area surrounding the vehicle is dark because the headlights do not illuminate the area. In the image sensor, therefore, the IR filter is not arranged in a peripheral area of the imaging surface excluding a central portion thereof. Configuring the image sensor in this manner can improve the sensitivity of the peripheral area. In a case where the image sensor is configured in this manner, it is possible to accurately recognize a subject by performing recognition processing while switching between a recognizer suitable for the area in which the IR filter is arranged and a recognizer suitable for the area in which the IR filter is not arranged.

The series of the processes described in the specification can be performed by hardware, software, or a combination thereof. In a case where processing is to be performed by software, a program recording a process sequence is installed in a memory of a computer incorporated into dedicated hardware, and executed. Alternatively, the program can be installed and executed in a general-purpose computer capable of performing various kinds of processes.

For example, the program can be recorded in advance in a hard disk, an SSD (Solid State Drive), or a ROM (Read Only Memory) as a recording medium. Alternatively, the program can be temporarily or permanently stored (recorded) in a removable recording medium such as a flexible disk, a CD-ROM (Compact Disc Read Only Memory), an MO (Magneto optical) disk, a DVD (Digital Versatile Disc), a BD (Blu-Ray Disc) (registered trademark), a magnetic disk, or a semiconductor memory card. Such a removable recording medium can be provided as, what is called, a package software.

Further, the program may be installed from the removable recording medium into the computer, or may be wirelessly or wiredly transferred from a download site to the computer via a network such as a LAN (Local Area Network) or the Internet. The computer can receive the program transferred in this manner and install the program into a recording medium such as a built-in hard disk.

It is noted that the effects described in the present specification are merely examples and are not limited to those examples. Additional effects that are not described may be exhibited. Further, the present technology should not be construed as limited to the embodiments of the above-described technology. The embodiments of the present technology disclose the present technology in the form of exemplification, and it is obvious that those skilled in the art can make modifications or substitutions of the embodiments without departing from the gist of the present technology. That is, the claims should be taken into consideration to determine the gist of the present technology.

Further, the image processing apparatus according to the present technology can also have the following configurations.

(1) An image processing apparatus including:

a recognition processing section configured to perform subject recognition in a processing area in an image obtained by an imaging section, by using a recognizer corresponding to an image characteristic of the processing area.

(2) The image processing apparatus according to (2), in which the recognition processing section determines the image characteristic of the processing area on the basis of a characteristic map indicating an image characteristic of the image obtained by the imaging section.

(3) The image processing apparatus according to (2),

in which the characteristic map includes a map based on an optical characteristic of an imaging lens used in the imaging section, and

on the basis of the image characteristic of the processing area, the recognition processing section switches between recognizers configured to perform the subject recognition.

(4) The image processing apparatus according to (3),

in which the image characteristic includes resolution, and

the recognition processing section performs the subject recognition using a recognizer corresponding to the resolution of the processing area.

(5) The image processing apparatus according to (3) or (4),

in which the image characteristic includes skewness, and

the recognition processing section performs the subject recognition using a recognizer corresponding to the skewness of the processing area.

(6) The image processing apparatus according to any of (3) to (5), in which the recognition processing section adjusts a template size or an amount of movement of a template of the recognizer according to the optical characteristic of the imaging lens.

(7) The image processing apparatus according to any of (3) to (6), further including:

a lens selection section configured to select an imaging lens corresponding to an imaging scene; and

a characteristic information storage section configured to output, to the recognition processing section, the characteristic map corresponding to the imaging lens selected by the lens selection section,

in which the recognition processing section determines, on the basis of the characteristic map supplied from the characteristic information storage section, the image characteristic of the processing area in the image obtained by the imaging section using the imaging lens selected by the lens selection section.

(8) The image processing apparatus according to (7), in which the lens selection section determines the imaging scene on the basis of at least any of image information acquired by the imaging section, operation information of a mobile object including the imaging section, or environment information indicating an environment in which the imaging section is used.

(9) The image processing apparatus according to any of (3) to (8), in which the imaging lens has a wide angle of view in all directions or in a predetermined direction and the optical characteristic of the imaging lens differs depending on a position on the lens.

(10) The image processing apparatus according to any of (2) to (9),

in which the characteristic map includes a map based on a filter arrangement state of an image sensor used in the imaging section, and

on the basis of the image characteristic of the processing area, the recognition processing section switches between recognizers configured to perform the subject recognition.

(11) The image processing apparatus according to (10),

in which the filter arrangement state includes an arrangement state of a color filter, and

according to an arrangement of the color filter in the processing area, the recognition processing section switches between the recognizers configured to perform the subject recognition.

(12) The image processing apparatus according to (11), in which the arrangement state of the color filter includes a state in which, in a central portion of an imaging area in the image sensor, the color filter is not arranged or a filter configured to transmit only a specific color is arranged.

(13) The image processing apparatus according to any of (10) to (12),

in which the filter arrangement state indicates an arrangement state of an infrared cut-off filter, and

according to an arrangement of the infrared cut-off filter in the processing area, the recognition processing section switches between the recognizers configured to perform the subject recognition.

(14) The image processing apparatus according to (13), in which the arrangement state of the infrared cut-off filter includes a state in which the infrared cut-off filter is arranged only in a central portion of an imaging area in the image sensor.

(15) The image processing apparatus according to any of (1) to (14), further including:

the imaging section.

### INDUSTRIAL APPLICABILITY

The image processing apparatus, the image processing method, and the program according to the present technology perform subject recognition in a processing area in an image obtained by the imaging section, by using a recognizer corresponding to an image characteristic of the processing area. Therefore, since subject recognition can be performed accurately, the image processing apparatus, the image processing method, and the program according to the present technology are suitable for cases where a mobile object performs automatic driving, for example.

### REFERENCE SIGNS LIST

10 . . . Imaging system
20-1, 20-2, 20-3 . . . Imaging section
21, 21a, 21b . . . Imaging lens
22, 24 . . . Image sensor
23 . . . Lens switching section
30-1, 30-2, 30-3 . . . Image processing section
31, 33, 34 . . . Characteristic information storage section
32 . . . Lens selection section
35 . . . Recognition processing section
351 . . . Recognizer switching section
352-1 to 352-n . . . Recognizer

1. An image processing apparatus comprising:
a recognition processing section configured to perform subject recognition in a processing area in an image obtained by an imaging section, by using a recognizer corresponding to an image characteristic of the processing area.

2. The image processing apparatus according to claim 1, wherein the recognition processing section determines the image characteristic of the processing area on a basis of a characteristic map indicating an image characteristic of the image obtained by the imaging section.

3. The image processing apparatus according to claim 2,
wherein the characteristic map includes a map based on an optical characteristic of an imaging lens used in the imaging section, and
on a basis of the image characteristic of the processing area, the recognition processing section switches between recognizers configured to perform the subject recognition.

4. The image processing apparatus according to claim 3,
wherein the image characteristic includes resolution, and
the recognition processing section performs the subject recognition using a recognizer corresponding to the resolution of the processing area.

5. The image processing apparatus according to claim 3,
wherein the image characteristic includes skewness, and
the recognition processing section performs the subject recognition using a recognizer corresponding to the skewness of the processing area.

6. The image processing apparatus according to claim 3, wherein the recognition processing section adjusts a template size or an amount of movement of a template of the recognizer according to the optical characteristic of the imaging lens.

7. The image processing apparatus according to claim 3, further comprising:
a lens selection section configured to select an imaging lens corresponding to an imaging scene; and
a characteristic information storage section configured to output, to the recognition processing section, the characteristic map corresponding to the imaging lens selected by the lens selection section,
wherein the recognition processing section determines, on a basis of the characteristic map supplied from the characteristic information storage section, the image characteristic of the processing area in the image obtained by the imaging section using the imaging lens selected by the lens selection section.

8. The image processing apparatus according to claim 7, wherein the lens selection section determines the imaging scene on a basis of at least any of image information acquired by the imaging section, operation information of a mobile object including the imaging section, or environment information indicating an environment in which the imaging section is used.

9. The image processing apparatus according to claim 3, wherein the imaging lens has a wide angle of view in all directions or in a predetermined direction and the optical characteristic of the imaging lens differs depending on a position on the lens.

10. The image processing apparatus according to claim 2,
wherein the characteristic map includes a map based on a filter arrangement state of an image sensor used in the imaging section, and
on a basis of the image characteristic of the processing area, the recognition processing section switches between recognizers configured to perform the subject recognition.

11. The image processing apparatus according to claim 10,
wherein the filter arrangement state includes an arrangement state of a color filter, and
according to an arrangement of the color filter in the processing area, the recognition processing section switches between the recognizers configured to perform the subject recognition.

12. The image processing apparatus according to claim 11, wherein the arrangement state of the color filter includes a state in which, in a central portion of an imaging area in the image sensor, the color filter is not arranged or a filter configured to transmit only a specific color is arranged.

13. The image processing apparatus according to claim 10,
wherein the filter arrangement state indicates an arrangement state of an infrared cut-off filter, and
according to an arrangement of the infrared cut-off filter in the processing area, the recognition processing section switches between the recognizers configured to perform the subject recognition.

14. The image processing apparatus according to claim 13, wherein the arrangement state of the infrared cut-off filter includes a state in which the infrared cut-off filter is arranged only in a central portion of an imaging area in the image sensor.

15. The image processing apparatus according to claim 1, further comprising:
the imaging section.

16. An image processing method comprising:
performing, by a recognition processing section, subject recognition in a processing area in an image obtained by an imaging section, by using a recognizer corresponding to an image characteristic of the processing area.

17. A program for causing a computer to perform recognition processing, the program causing the computer to perform:
a process of detecting an image characteristic of a processing area in an image obtained by an imaging section; and
a process of causing subject recognition to be performed in the processing area using a recognizer corresponding to the detected image characteristic.
